(19) United States
(12) Patent Application Publication
(10) Pub. No.: US 2026/0245920 A1
(43) Pub. Date: Aug. 20, 2026

(54) FUEL CELL UNIT

(71) Applicant: HONDA MOTOR CO., LTD., TOKYO (JP)

(72) Inventors: Shota FUJIMURA, WAKO-SHI (JP); Ryota KITAMOTO, WAKO-SHI (JP); Takanori MORI, WAKO-SHI (JP)

(21) Appl. No.: 19/540,851

(22) Filed: Feb. 16, 2026

(30) Foreign Application Priority Data
Feb. 18, 2025 (JP) 2025-024318

(51) Int. Cl. H01M 8/0273; H01M 8/04029; H01M 8/04082; H01M 8/04858; H02B 1/20; H02B 1/48

(52) U.S. Cl. CPC H01M 8/0273; H01M 8/04029; H01M 8/04201; H01M 8/0494; H02B 1/202; H02B 1/48

(57) ABSTRACT

A fuel cell unit including: a stack case configured to house a fuel cell; a high-voltage power source device configured to boost electrical power generated by the fuel cell and output boosted electrical power to an external high-voltage power supply line; a power source case that is attached to the stack case, houses the high-voltage power source device, and includes a cooling mechanism configured to cool the high-voltage power source device; and a low-voltage power source device configured to convert electrical power supplied from an external low-voltage power supply line into an internal voltage for driving auxiliary equipment, wherein the low-voltage power source device is arranged inside the power source case, and a circuit substrate of the low-voltage power source device is in surface contact with an inner surface of the power source case.

### CROSS-REFERENCE TO RELATED APPLICATIONS

This application is based upon and claims the benefit of priority from Japanese Patent Application No. 2025-024318 filed on Feb. 18, 2025, the contents of which are incorporated herein by reference.

### BACKGROUND OF THE INVENTION

### Field of the Invention

The present disclosure relates to a fuel cell unit.

### Description of the Related Art

In recent years, research and development have been conducted on fuel cells that contribute to energy efficiency in order to ensure that more people have access to affordable, reliable, sustainable and modern energy (for example, JP 2023-173592 A).

### SUMMARY OF THE INVENTION

In the art relating to fuel cells, there is a demand for improved usability as a general-purpose product that can be used not only in passenger cars but also in various application devices such as trucks and stationary power sources. In order to satisfy the usability as a general-purpose product, it is conceivable to accommodate the fuel cell and all auxiliary equipment in a rectangular parallelepiped box-shaped region (envelope) having a predetermined dimension agreed with manufacturers of application devices. The fuel cell unit accommodated in such a box-shaped region can be easily mounted on application devices without affecting the arrangement of other components inside the application devices.

On the other hand, the fuel cell unit needs to receive electrical power supply from a power supply system provided within the application device in order to operate the auxiliary equipment. Since the power supply system of the application device has various voltages, the fuel cell unit is required to be equipped with a low-voltage power supply device that converts the electrical power supplied from the application device into an internal voltage suitable for driving the auxiliary equipment.

Since a current of several tens to several hundreds of amperes is required to drive the auxiliary equipment of the fuel cell unit, the heat generation of the low-voltage power supply device becomes significant. Therefore, with a commercially-available low-voltage power supply device equipped with large and bulky heat dissipation fins, there is a problem regarding its ability to be accommodated inside a box-shaped region.

The present disclosure has been made to solve the above problems, and an object of the present disclosure is to achieve mounting of a low-voltage power supply device in a compact space. The present invention thus contributes to energy efficiency.

An aspect of the present disclosure is characterized by a fuel cell unit including: a stack case configured to house a fuel cell; a high-voltage power source device configured to boost electrical power generated by the fuel cell and output boosted electrical power to an external high-voltage power supply line; a power source case that is attached to the stack case, houses the high-voltage power source device, and includes a cooling mechanism configured to cool the high-voltage power source device; and a low-voltage power source device configured to convert electrical power supplied from an external low-voltage power supply line into an internal voltage for driving auxiliary equipment, wherein the low-voltage power source device is arranged inside the power source case, and a circuit substrate of the low-voltage power source device is in surface contact with an inner surface of the power source case.

According to the present disclosure, the low-voltage power source device is compactly mounted on the fuel cell unit, and the low-voltage power source device can be accommodated inside an envelope.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a configuration diagram of a low-voltage system of a fuel cell unit according to an embodiment;

FIG. 2 is a perspective view of the fuel cell unit according to the embodiment;

FIG. 3 is an explanatory view of a first mounting region and a second mounting region that constitute an envelope of the fuel cell unit;

FIG. 4 is a cross-sectional view of a power source case taken along line IV-IV of FIG. 2, in which cross sections of components other than an internal power source system are omitted; and

FIG. 5 is a cross-sectional view taken along line V-V of FIG. 2, in which cross sections of components other than an internal power source system are omitted.

### DETAILED DESCRIPTION OF THE INVENTION

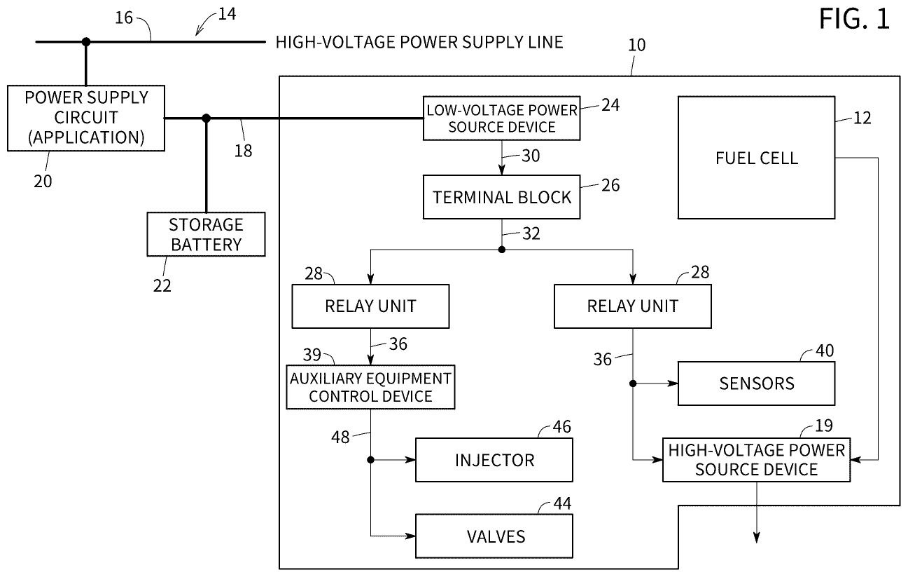

As shown in FIG. 1, a fuel cell unit 10 of the present embodiment includes a fuel cell 12 and supplies electrical power generated by the fuel cell 12 to an application device 14. The application device 14 is, for example, a passenger car, a truck, a stationary power source, or the like. The application device 14 includes a high-voltage power supply line 16 and a low-voltage power supply line 18. Through the high-voltage power supply line 16, electrical power is supplied to a driving motor or the like that consumes relatively large electrical power in the application device 14. The electrical power of the fuel cell 12 is supplied to the high-voltage power supply line 16 through a high-voltage power source device 19 (VCU) to be described later.

The low-voltage power supply line 18 includes a power supply circuit 20. The power supply circuit 20 converts a high-voltage electrical power supplied through the high-voltage power supply line 16 into a low-voltage electrical power suitable for operation of a low-voltage device in the application device 14 and the low-voltage electrical power is supplied to the low-voltage power supply line 18. The power supply circuit 20 supplies DC electrical power at, for example, 12 V, 24 V, or 48 V, depending on the type of application device 14. The low-voltage power supply line 18 includes a storage battery 22. The storage battery 22 supplies the fuel cell unit 10 with electrical power necessary for driving a control device and auxiliary equipment of the fuel cell unit 10.

The fuel cell unit 10 includes a low-voltage power source device 24 that converts electrical power supplied from the low-voltage power supply line 18 into a predetermined internal voltage. The low-voltage power source device 24 outputs, for example, DC electrical power at 12 V as the internal voltage. The fuel cell unit 10 includes a terminal block 26 and relay units 28 in order to distribute the electrical power from the low-voltage power source device 24 to the auxiliary equipment and the control devices of the respective parts.

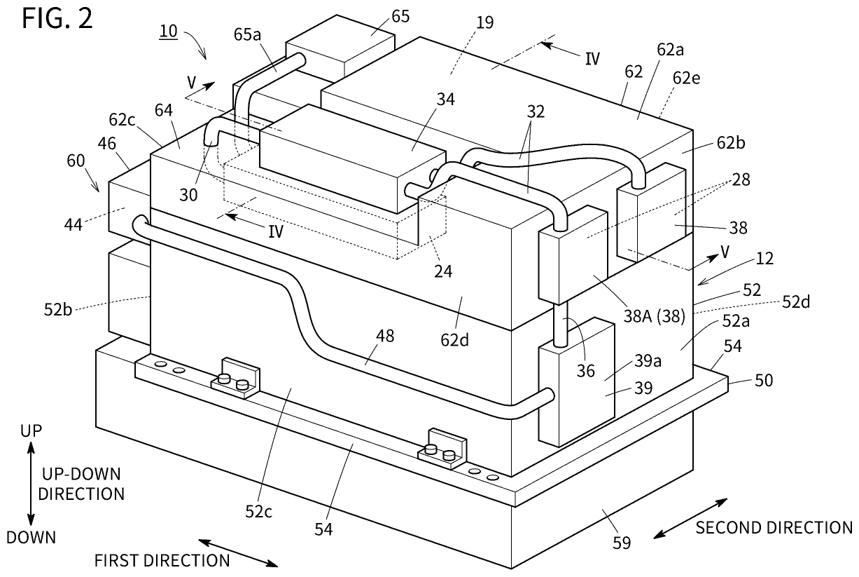

The terminal block 26 is connected to the low-voltage power source device 24 through a first line 30. The terminal block 26 connects the first line 30 and a plurality of second lines 32 extending toward the relay units 28. The terminal block 26 is housed in a terminal box 34 (see FIG. 2).

The relay units 28 are connected to the terminal block 26 through the second lines 32. Each of the relay units 28 connects one of the second lines 32 to third lines 36 directed to the auxiliary equipment of the respective parts. A plurality of relay units 28 may be provided according to the number of second lines 32 and third lines 36. In the example shown in FIG. 1, the fuel cell unit 10 includes two relay units 28. A plurality of second lines 32 and third lines 36 may be connected to each of the relay units 28. The relay unit 28 includes a relay capable of selectively cutting off electrical connection between the low-voltage power source device 24 and auxiliary equipment of the respective parts, and a fuse that cuts off electrical connection between the low-voltage power source device 24 and the third lines 36 at an event of an electric leakage or the like. The relay unit 28 is housed in a relay box 38 (see FIG. 2).

Examples of the devices connected to the third lines 36 include an auxiliary equipment control device 39, the high-voltage power source device 19, and sensors 40. The auxiliary equipment control device 39 is a control device that controls a fuel gas supply unit 60 (see FIG. 2). Valves 44 of the fuel gas supply unit 60 and an injector 46 are further connected to the auxiliary equipment control device 39. The auxiliary equipment control device 39 and the injector 46 are connected to each other through a fourth line 48.

The high-voltage power source device 19 includes a voltage conversion circuit that boosts a voltage of the electrical power generated by the fuel cell 12 to a voltage for the high-voltage power supply line 16 of the application device 14 and outputs the boosted voltage. A control unit of the high-voltage power source device 19 operates on the internal voltage supplied by the low-voltage power source device 24. An output terminal of the high-voltage system circuit of the high-voltage power source device 19 is connected to the high-voltage power supply line 16.

The layout of the fuel cell unit 10 will be described below. In the following description, terms such as a first direction, a second direction, and an up-down direction are used to indicate the shape, positional relationship, and the like of the components. The first direction is a direction that coincides with the stacking direction of the power generation cells of the fuel cell 12. The second direction is a direction orthogonal to the first direction and is a direction along the planar direction of the power generation cells. The up-down direction is a direction orthogonal to the first direction and the second direction.

As shown in FIG. 2, the fuel cell unit 10 includes a support frame 50. The support frame 50 is a flat plate-shaped member extending along the first direction and the second direction, and supports the fuel cell 12. The support frame 50 includes a coupling portion 54 having sides protruding outward from the stack case 52 of the fuel cell 12 in the second direction. The coupling portion 54 is usable for attaching the fuel cell unit 10 to a frame or the like of the application device 14.

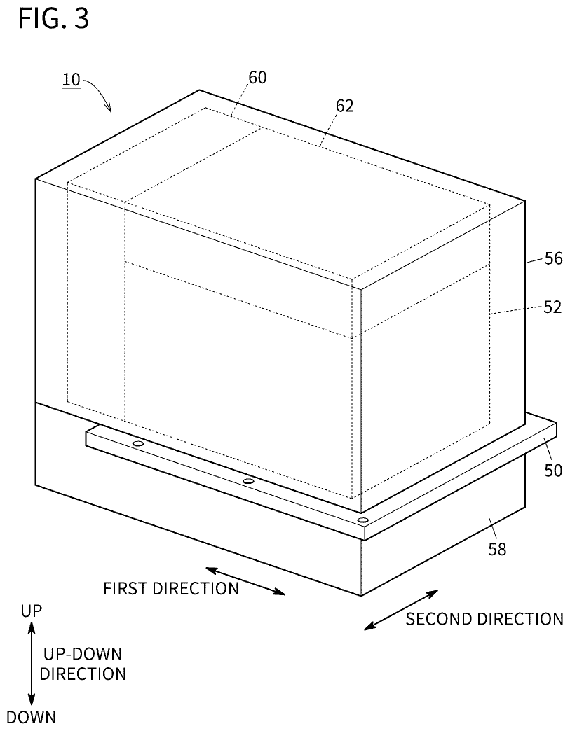

As shown in FIG. 3, a first mounting region 56 constituting one part of an envelope is set on the support frame 50, and a second mounting region 58 constituting another part of the envelope is set under the support frame 50. The first mounting region 56 and the second mounting region 58 constitute the envelope. The first mounting region 56 is a rectangular parallelepiped box-shaped region extending in the first direction, the second direction, and the up-down direction. The first mounting region 56 is larger than the stack case 52 of the fuel cell 12, and the auxiliary equipment are mounted in a space between the first mounting region 56 and the stack case 52. In addition to the fuel cell 12, the fuel gas supply unit 60, the auxiliary equipment control device 39, the high-voltage power source device 19, the low-voltage power source device 24, the terminal block 26, the relay box 38, and the like are mounted in the first mounting region 56.

The second mounting region 58 is a rectangular parallelepiped box-shaped region extending in the first direction, the second direction, and the up-down direction, and extends downward of the support frame 50. The second mounting region 58 has the same dimensions in the first direction and the second direction as the first mounting region 56, and has a smaller dimension in the up-down direction than the dimension in the up-down direction of the first mounting region 56. Auxiliary equipment of an oxygen-containing gas supply unit 59, such as a compressor of an oxygen-containing gas system, a heat exchanger, a humidifier, and a gas-liquid separator, and part of the auxiliary equipment of the fuel gas supply unit 60 are mounted in the second mounting region 58.

The fuel cell 12 is housed inside the stack case 52 having a rectangular parallelepiped shape extending in the first direction, the second direction, and the up-down direction. The stack case 52 has a first side surface 52a located at one end in the first direction, a second side surface 52b located at the other end in the first direction, a third side surface 52c located at one end in the second direction, and a fourth side surface 52d located at the other end in the second direction. The fuel gas supply unit 60 is mounted between the second side surface 52b of the stack case 52 and the first mounting region 56.

The dimension of the stack case 52 in the up-down direction is smaller than the dimension of the first mounting region 56 in the up-down direction. The devices of power supply system that generate a relatively large amount of heat, such as the high-voltage power source device 19 and the low-voltage power source device 24, are disposed in a concentrated manner on the stack case 52.

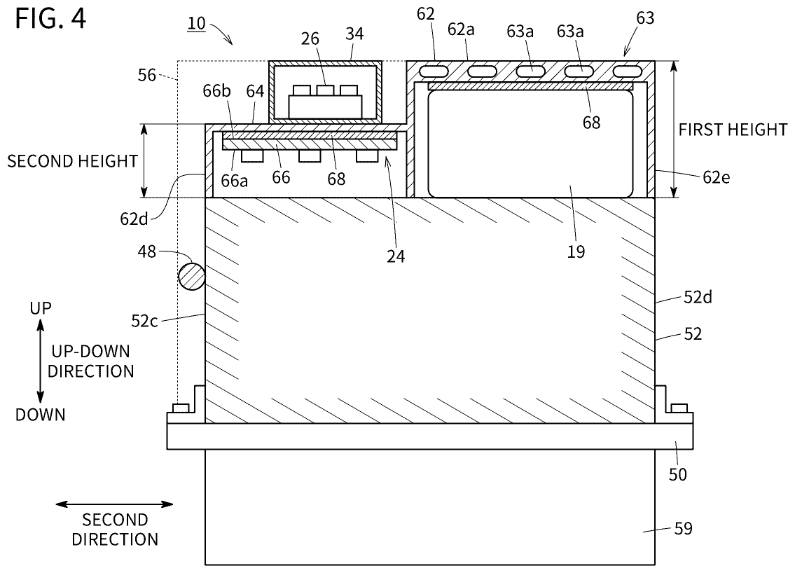

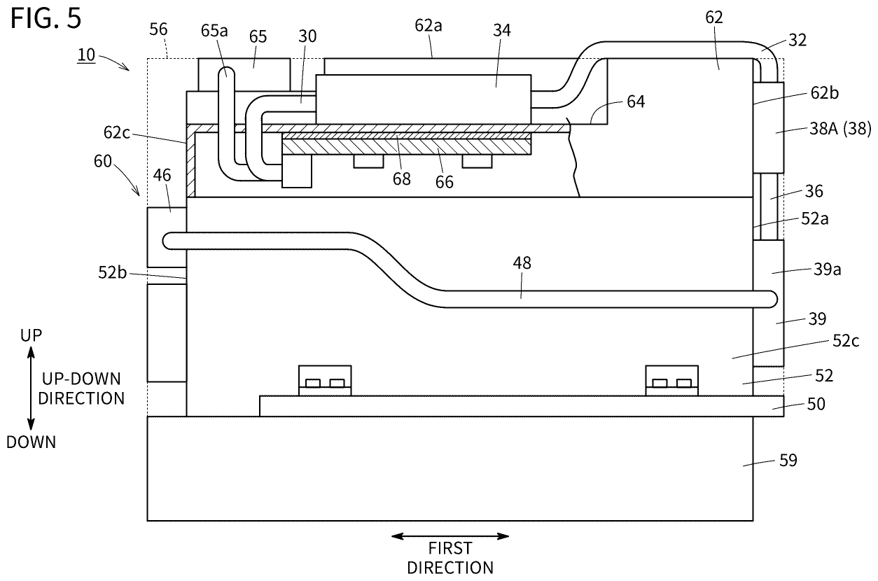

As shown in FIGS. 4 and 5, the low-voltage power source device 24 and the high-voltage power source device 19 are housed inside a power source case 62. The power source case 62 covers the upper portion of the stack case 52. A waterproof seal is disposed at a contact portion between the power source case 62 and the stack case 52, and the power source case 62 internally forms a waterproof accommodation space. The power source case 62 has an upper surface portion 62a, a first sidewall 62b, a second sidewall 62c, a third sidewall 62d, and a fourth sidewall 62e. The upper surface portion 62a constitutes an upper end of the power source case 62. The uppermost surface in the upper surface portion 62a is located at substantially the same height as the upper end of the first mounting region 56.

The first sidewall 62b, the second sidewall 62c, the third sidewall 62d, and the fourth sidewall 62e extend downward respectively from four sides of the upper surface portion 62a and make close contact with the stack case 52. The first sidewall 62b is one end in the first direction and is located above the first side surface 52a of the stack case 52. The first sidewall 62b is aligned on substantially the same plane as the first side surface 52a. The second sidewall 62c is the other end in the first direction and is located above the second side surface 52b of the stack case 52. The second sidewall 62c is aligned on substantially the same plane as the second side surface 52b.

The third sidewall 62d of the power source case 62 is one end in the second direction and is aligned on substantially the same plane as the third side surface 52c of the stack case 52. The fourth sidewall 62e is the other end in the second direction and is aligned on substantially the same plane as the fourth side surface 52d of the stack case 52.

The power source case 62 is formed of metal or the like having excellent thermal conductivity such as an aluminum alloy. The heat generating component of the high-voltage power source device 19 having a large heat generation amount is in surface contact with the upper surface portion 62a of the power source case 62 via a heat conductive material or the like (grease, a heat conductive sheet 68 as in the illustrated embodiment, or the like). As shown in FIG. 4, the upper surface portion 62a of the power source case 62 includes a cooling mechanism 63. The cooling mechanism 63 includes a refrigerant flow path 63a and cools a heat generating component such as the high-voltage power source device 19. At least a part of the refrigerant flow path 63a of the cooling mechanism 63 is overlaid on the upper side of the high-voltage power source device 19. A refrigerant such as water flows through the refrigerant flow path 63a. The refrigerant flow path 63a together with the coolant for the fuel cell 12 are cooled by external radiators or the like. The cooling mechanism 63 may further include heat dissipation fins.

The power source case 62 is stacked on the upper end of the stack case 52 so that the uppermost surface (first part) of the upper surface portion 62a of the power source case 62 is positioned at a first height from the upper end of the stack case 52. The position of the uppermost surface of the upper surface portion 62a in the up-down direction is substantially the same as the position of the upper end of the first mounting region 56. A part of the upper surface portion 62a of the power source case 62 is recessed to form a recess 64 (second part) having a recessed surface positioned lower than the upper end of the first mounting region 56. The recessed surface of the recess 64 is positioned at a second height lower than the first height from the upper end of the stack case 52. The recess 64 is provided adjacent to the third sidewall 62d in the power source case 62.

A power source connector 65 for connection to the low-voltage power supply line 18 of the application device 14 is provided at a predetermined position on the upper surface portion 62a of the power source case 62. The power source connector 65 is connected to the low-voltage power source device 24 through a power source line 65a.

The low-voltage power source device 24 is mounted in a space between the recessed surface of the recess 64 and the upper end of the stack case 52. The low-voltage power source device 24 generates a smaller voltage and a smaller current than the high-voltage power source device 19, and is therefore formed to be smaller than the high-voltage power source device 19. Therefore, the low-voltage power source device 24 can be accommodated in the space between the recessed surface of the recess 64 and the upper end of the stack case 52.

As shown in FIG. 4, the low-voltage power source device 24 includes a circuit substrate 66 and electronic components mounted on the first surface 66a of the circuit substrate 66. The second surface 66b of the circuit substrate 66 is formed to be flat.

The circuit substrate 66 has through holes (not shown) formed at a plurality of positions. The circuit substrate 66 is attached to the recessed upper surface portion of the power source case 62 by screwing fastening members such as screws into these through holes. The second surface 66b of the circuit substrate 66 is attached to the power source case 62 through a heat conductive sheet 68 having elasticity.

Heat from heat generating components of the low-voltage power source device 24 is transferred via the circuit substrate 66 to the power source case 62 having the cooling mechanism 63, and is thereby efficiently dissipated. Therefore, in the fuel cell unit 10 according to the present embodiment, it is not necessary to attach a bulky heat dissipation component such as heat dissipation fins to the low-voltage power source device 24, and the low-voltage power source device 24 can be mounted compactly.

The terminal box 34 is disposed on the recess 64. The terminal box 34 is a case that accommodates the terminal block 26. The terminal box 34 has a dimension in the up-down direction smaller than the depth of the recess 64 in the up-down direction. Therefore, the sum of the second height of the recess 64 and the height of the terminal box 34 is equal to or smaller than the first height. That is, the terminal box 34 is disposed in the recess 64 of the power source case 62 such that the upper end of the terminal box 34 does not protrude upward from the uppermost surface (first part) of the upper surface portion 62a of the power source case 62.

A plurality of terminal boxes 34 may be provided according to the number of second lines 32 connected to the rely boxes 38. The terminal box 34 in the recess 64 is located above the low-voltage power source device 24. The terminal box 34 and the low-voltage power source device 24 face each other with the upper surface portion of the power source case 62 interposed therebetween. With such an arrangement, the first line 30 connecting the low-voltage power source device 24 and the terminal box 34 is minimized, and the voltage drop caused by the wiring resistance of the first line 30 is reduced.

As shown in FIG. 2, the plurality of second lines 32 extend from the terminal box 34 toward the first sidewall 62b of the power source case 62. The relay box 38 is connected to the second line 32. The relay box 38 is attached to the first sidewall 62b of the power source case 62. The upper portion of the relay box 38 is configured to be openable and closable so that a fuse inside the relay box 38 can be replaced. To facilitate fuse replacement, the relay box 38 is disposed near the upper end of the first mounting region 56.

In the present embodiment, the fuel cell unit 10 has two relay boxes 38. The relay box 38 disposed in the path for supplying electrical power to the auxiliary equipment control device 39 is hereinafter referred to as a first relay box 38A. The first relay box 38A is disposed in the vicinity of the third sidewall 62d of the power source case 62. The first relay box 38A is located above the auxiliary equipment control device 39 attached to the first side surface 52a. The first relay box 38A and the auxiliary equipment control device 39 are connected to each other through a third line 36 extending in the up-down direction. With this arrangement of the first relay box 38A, the path length of the third line 36 is minimized, and the voltage drop caused by the wiring resistance of the third line 36 is reduced.

Since the relay boxes 38 and the auxiliary equipment control device 39 are components for controlling a large current, they are preferably provided at positions away from the fuel gas supply unit 60 where the combustible fuel gas may leak. Therefore, the relay box 38 and the auxiliary equipment control device 39 are disposed on the side of the first side surface 52a of the stack case 52. The first side surface 52a is the farthest from the second side surface 52b where the fuel gas supply unit 60 is disposed. The auxiliary equipment control device 39 is disposed near the center of the stack case 52 in the up-down direction. The auxiliary equipment control device 39 is disposed on the first side surface 52a at a position as close as possible to the third side surface 52c.

The auxiliary equipment control device 39 is housed in a control box 39a. A plurality of fourth lines 48 extend from the control box 39a toward the valves 44 of the fuel gas supply unit 60 (see FIG. 1) and the injector 46. The injector 46 requires a relatively large current for operation, and it becomes difficult for the injector 46 to operate normally when the voltage drops. Therefore, it is desirable to minimize the voltage drop caused by the wiring resistance of the fourth line 48 connecting the auxiliary equipment control device 39 and the injector 46.

Therefore, in the first side surface 52a of the stack case 52, the control box 39a is disposed closest to the third side surface 52c. The fourth line 48 extending from the auxiliary equipment control device 39 extends on the third side surface 52c along the first direction. A portion of the fourth line 48 is bent at the second side surface 52b and connected to the injector 46. In the vicinity of the upper end of the second side surface 52b, the injector 46 is disposed close to the third side surface 52c. Therefore, the fourth line 48 arranged in this manner can connect the auxiliary equipment control device 39 and the injector 46 with a short path, and the voltage drop caused by the internal resistance is reduced.

The low-voltage power source device 24, the terminal box 34, the relay box 38, and the auxiliary equipment control device 39 are disposed at positions close to the third side surface 52c. Accordingly, the length of the line from the low-voltage power source device 24 to the injector 46 is shortened, and a sufficient drive current can be supplied to the injector 46 without excessively increasing the diameters of the first line 30, the second line 32, the third lines 36, and the fourth line 48. This enables the fuel cell unit 10 to reduce the diameters of the first line 30, the second line 32, the third line 36, and the fourth line 48, and to make the wiring compact.

A fuel gas supply unit 60 is provided on the side of the second side surface 52b of the stack case 52. The fuel gas supply unit 60 includes a gas-liquid separator, circulation piping, the injector 46, an ejector, and valves. The circulation piping forms a flow path connecting an anode outlet of the fuel cell 12 to an anode inlet thereof to circulate hydrogen gas as fuel gas. The gas-liquid separator is attached to the circulation piping and separates and removes water from the unconsumed hydrogen gas discharged from the fuel cell 12. The ejector is a jet pump attached to the circulation piping, and utilizes the flow of the high-pressure hydrogen gas jetted from the injector 46 to causes the hydrogen gas inside the circulation piping to flow. The injector 46 includes a solenoid valve that injects hydrogen gas into the ejector. The injector 46 injects hydrogen gas supplied from a high-pressure hydrogen cylinder into the ejector.

The connector of the injector 46 is arranged near the third side surface 52c and is connected to the auxiliary equipment control device 39 through the fourth line 48.

As described above, the fuel cell unit 10 of the present embodiment can achieve compact mounting of the low-voltage power source device 24. Further, by separating the terminal box 34 and the relay boxes 38, the terminal box 34 and the relay boxes 38 can be efficiently mounted in the limited space between the first mounting region 56 and the stack case 52. Further, the path from the low-voltage power source device 24 to the injector 46 via the auxiliary equipment control device 39 can be shortened while the auxiliary equipment control device 39 is disposed at a safe position. Such an arrangement can make the lines small in size, and the wiring can be made compactly.

The following supplementary notes are further disclosed in relation to the above embodiment.

### Supplementary Note 1

The fuel cell unit (10) of the present disclosure includes: the stack case (52) configured to house the fuel cell (12); the high-voltage power source device (19) configured to boost electrical power generated by the fuel cell and output boosted electrical power to the external high-voltage power supply line (16); the power source case (62) that is attached to the stack case, houses the high-voltage power source device, and includes the cooling mechanism (63) configured to cool the high-voltage power source device; and the low-voltage power source device (24) configured to convert electrical power supplied from the external low-voltage power supply line (18) into an internal voltage for driving auxiliary equipment, wherein the low-voltage power source device is arranged inside the power source case, and the circuit substrate (66) of the low-voltage power source device is in surface contact with an inner surface of the power source case.

The fuel cell unit described above can be equipped with a low-voltage power source device in a compact manner.

### Supplementary Note 2

In the fuel cell unit according to the Supplementary Note 1, the power source case may include a first part extended with a first height from the stack case and a second part extended with a second height from the stack case, the high-voltage power source device may be housed in the first part, and the low-voltage power source device may be attached to an inner surface of the second part. In this fuel cell unit, a space capable of arranging components of the power supply system can be provided on the second part, and the components of the power supply system can be mounted compactly.

### Supplementary Note 3

The fuel cell unit according to Supplementary Note 2 may further include the terminal block (26) that connects, to the low-voltage power source device, the plurality of lines connected to the auxiliary equipment, and the relay unit (28) configured to electrically connect or disconnect the auxiliary equipment and the low-voltage power source device, wherein the terminal box (34) that houses the terminal block and the relay box (38) that houses the relay unit may be separate boxes and may be disposed away from each other. The fuel cell unit can be compactly equipped with the terminal block and the relay unit.

### Supplementary Note 4

In the fuel cell unit according to Supplementary Note 3, the terminal box may be disposed on the second part, and a sum of a height of the terminal box and the second height may be equal to or smaller than the first height. The fuel cell unit can be mounted with the terminal box in a compact manner.

### Supplementary Note 5

In the fuel cell unit according to Supplementary Note 4, the relay box may be attached to a side portion of the power source case so as to protrude laterally beyond the first side surface (52a) of the stack case, and may be located above the stack case. Since the relay box is disposed at the position easily accessible from above in terms of maintenance, the fuel cell unit is excellent in workability such as fuse replacement.

### Supplementary Note 6

The fuel cell unit according to Supplementary Note 5 may further include the auxiliary equipment control device (39) that is connected to the low-voltage power source device via the relay box and the terminal block and is configured to drive the auxiliary equipment, and the control box (39a) configured to accommodate the auxiliary equipment control device, wherein the control box may be attached to the first side surface of the stack case below the relay box. In this fuel cell unit, the length of the line up to the auxiliary equipment control device can be shortened, and the voltage drop caused by the wiring resistance can be reduced.

### Supplementary Note 7

The fuel cell unit according to Supplementary Note 6 may further include the injector (46) that is attached to the second side surface (52b) of the stack case opposite to the first side surface and is configured to jet fuel gas to the fuel cell, wherein the fourth line (48) that connects the injector and the auxiliary equipment control device may be disposed along a side surface of the stack case. In this fuel cell unit, the length of the line from the low-voltage power source device to the injector can be shortened, so that a line having a smaller diameter can be used, and the line can be mounted in a compact manner.

### Supplementary Note 8

The fuel cell unit according to Supplementary Note 6 or 7 may further include the support frame (50) that supports the stack case from below, wherein the power source case, the terminal block, the relay box, and the control box may be disposed in the first mounting region (56) extending upward from the support frame. The fuel cell unit can be mounted on an application device without affecting the layout of components of the application device, and thus can be applied to various uses.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, these embodiments can also be implemented in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. A fuel cell unit comprising: a stack case configured to house a fuel cell;
a high-voltage power source device configured to boost electrical power generated by the fuel cell and output boosted electrical power to an external high-voltage power supply line;
a power source case that is attached to the stack case, houses the high-voltage power source device, and includes a cooling mechanism configured to cool the high-voltage power source device; and
a low-voltage power source device configured to convert electrical power supplied from an external low-voltage power supply line into an internal voltage for driving auxiliary equipment, wherein
the low-voltage power source device is arranged inside the power source case, and a circuit substrate of the low-voltage power source device is in surface contact with an inner surface of the power source case.

2. The fuel cell unit according to claim 1, wherein
the power source case includes a first part extended with a first height from the stack case and a second part extended with a second height from the stack case, and
the high-voltage power source device is housed in the first part, and the low-voltage power source device is attached to an inner surface of the second part.

3. The fuel cell unit according to claim 2, further comprising:
a terminal block that connects, to the low-voltage power source device, a plurality of lines connected to the auxiliary equipment, and
a relay unit configured to electrically connect or disconnect the auxiliary equipment and the low-voltage power source device, wherein
a terminal box that houses the terminal block and a relay box that houses the relay unit are separate boxes and are disposed away from each other.

4. The fuel cell unit according to claim 3, wherein
the terminal box is disposed on the second part, and a sum of a height of the terminal box and the second height is equal to or smaller than the first height.

5. The fuel cell unit according to claim 4, wherein
the relay box is attached to a side portion of the power source case so as to protrude laterally beyond a first side surface of the stack case, and the relay box is located above the stack case.

6. The fuel cell unit according to claim 5, further comprising:
an auxiliary equipment control device that is connected to the low-voltage power source device via the relay box and the terminal block and is configured to drive the auxiliary equipment, and
a control box configured to accommodate the auxiliary equipment control device, wherein
the control box is attached to the first side surface of the stack case below the relay box.

7. The fuel cell unit according to claim 6, further comprising:
an injector that is attached to a second side surface of the stack case opposite to the first side surface and is configured to jet fuel gas to the fuel cell, wherein
a fourth line that connects the injector and the auxiliary equipment control device are disposed along a side surface of the stack case.

8. The fuel cell unit according to claim 6, further comprising:
a support frame that supports the stack case from below, wherein
the power source case, the terminal block, the relay box, and the control box are disposed in a first mounting region extending upward from the support frame.
